(19) United States
(12) Patent Application Publication
(10) Pub. No.: US 2013/0107008 A1
(43) Pub. Date: May 2, 2013

(54) METHOD, APPARATUS AND COMPUTER PROGRAM PRODUCT FOR CAPTURING IMAGES

(71) Applicant: Nokia Corporation, Espoo (FI)

(72) Inventor: Veldandi Muninder, Bangalore (IN)

(73) Assignee: NOKIA CORPORATION, Espoo (FI)

(21) Appl. No.: 13/663,904

(22) Filed: Oct. 30, 2012

(30) Foreign Application Priority Data
Oct. 31, 2011 (IN) 3717/CHE/2011

(51) Int. Cl. H04N 13/02

(52) U.S. Cl. 348/46; 348/E13.074

(57) ABSTRACT

In accordance with various example embodiments, methods, apparatuses, and computer program products are provided. A method comprises facilitating capturing of a first image of a scene from a first position of the apparatus, tracking a movement of the apparatus for facilitating movement of the apparatus from the first position to a second position, and facilitating capturing of a second image of the scene from the second position of the apparatus. The apparatus comprises at least one processor and at least one memory comprising computer program code, configured to, cause the apparatus to perform facilitating capturing of a first image of a scene from a first position, tracking a movement of the apparatus for facilitating movement of the apparatus from the first position to a second position, and facilitating capturing of a second image of the scene from the second position of the apparatus.

### TECHNICAL FIELD

Various implementations relate generally to method, apparatus, and computer program product for capturing images.

### BACKGROUND

Various electronic devices such as cameras, mobile phones, and other devices having image capturing capabilities are available for capturing three-dimensional (3-D) images of a scene. Such devices may have two separate cameras positioned at different points that are utilized for capturing 3-D images. Two cameras of these devices generate a pair of two dimensional (2-D) monoscopic views of the scene. These views may be analogous to left and right eye perspective views. In such devises, a stereoscopic image can be generated by combining the pair of 2-d images captured by both cameras. For instance, the two 2-D perspective images are combined to form a 3-D or stereoscopic image.

### SUMMARY OF SOME EMBODIMENTS

Various aspects of examples embodiments are set out in the claims.

In a first aspect, there is provided a method comprising: facilitating capturing of a first image of a scene from a first position of an apparatus; tracking a movement of the apparatus for facilitating movement of the apparatus from the first position to a second position; and facilitating capturing of a second image of the scene from the second position of the apparatus.

In a second aspect, there is provided an apparatus comprising: at least one processor; and at least one memory comprising computer program code, the at least one memory and the computer program code configured to, with the at least one processor, cause the apparatus at least to perform: facilitating capturing of a first image of a scene from a first position of the apparatus; tracking a movement of the apparatus for facilitating movement of the apparatus from the first position to a second position; and facilitating capturing of a second image of the scene from the second position of the apparatus.

In a third aspect, there is provided a computer program product comprising at least one computer-readable storage medium, the computer-readable storage medium comprising a set of instructions, which, when executed by one or more processors, cause an apparatus to at least perform: facilitating capturing of a first image of a scene from a first position of the apparatus; tracking a movement of the apparatus for facilitating movement of the apparatus from the first position to a second position; and facilitating capturing of a second image of the scene from the second position of the apparatus.

In a fourth aspect, there is provided an apparatus comprising: means for facilitating capturing of a first image of a scene by the apparatus from a first position of the apparatus; means for tracking a movement of the apparatus for facilitating movement of the apparatus from the first position to a second position; and means for facilitating capturing of a second image of the scene by the apparatus from the second position of the apparatus.

In a fifth aspect, there is provided a computer program comprising program instructions which when executed by an apparatus, cause the apparatus to: facilitate capturing of a first image of a scene from a first position of an apparatus; track a movement of the apparatus for facilitating movement of the apparatus from the first position to a second position; and facilitate capturing of a second image of the scene by the apparatus from the second position of the apparatus.

### BRIEF DESCRIPTION OF THE FIGURES

Various embodiments are illustrated by way of example, and not by way of limitation, in the figures of the accompanying drawings in which:

FIG. 1 illustrates a device in accordance with an example embodiment;

FIG. 2 illustrates an apparatus for capturing of 3-D images in accordance with an example embodiment;

FIGS. 3A and 3B illustrate user interface for facilitating movement of the apparatus in accordance with an example embodiment;

FIG. 4 represents an image having depth information overlaid on the image in accordance with an example embodiment;

FIG. 5 is a flowchart of an example method in accordance with an example embodiment; and

FIG. 6 is a flowchart depicting an example method for generating 3-D images by an apparatus in accordance with an example embodiment.

### DETAILED DESCRIPTION

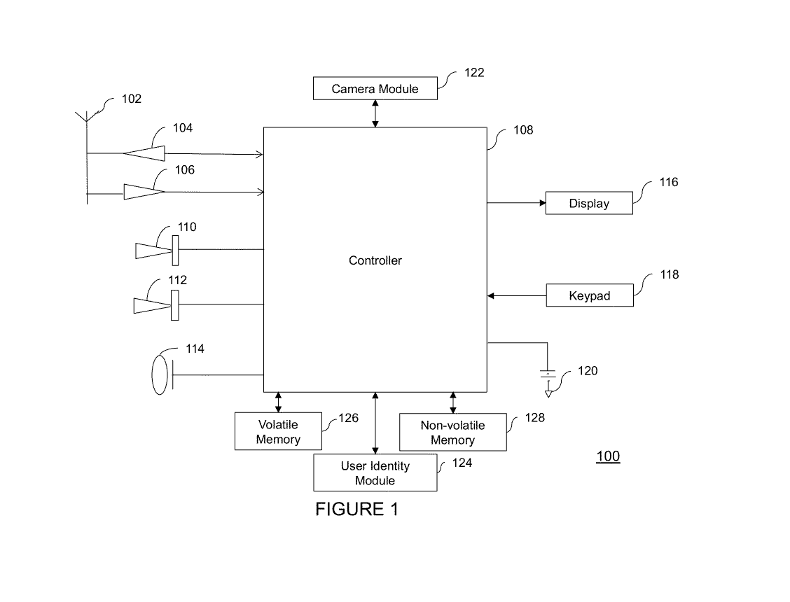

Example embodiments and their potential effects are understood by referring to FIGS. 1 through 6 of the drawings.

FIG. 1 illustrates a device 100 in accordance with an example embodiment. It should be understood, however, that the device 100 as illustrated and hereinafter described is merely illustrative of one type of device that may benefit from various embodiments, therefore, should not be taken to limit the scope of the embodiments. As such, it should be appreciated that at least some of the components described below in connection with the device 100 may be optional and thus in an example embodiment may include more, less or different components than those described in connection with the example embodiment of FIG. 1. The device 100 could be any of a number of types of mobile electronic devices, for example, portable digital assistants (PDAs), pagers, mobile televisions, gaming devices, cellular phones, all types of computers (for example, laptops, mobile computers or desktops), cameras, audio/video players, radios, global positioning system (GPS) devices, media players, mobile digital assistants, or any combination of the aforementioned, and other types of communications devices.

The device 100 may include an antenna 102 (or multiple antennas) in operable communication with a transmitter 104 and a receiver 106. The device 100 may further include an apparatus, such as a controller 108 or other processing device that provides signals to and receives signals from the transmitter 104 and receiver 106, respectively. The signals may include signaling information in accordance with the air interface standard of the applicable cellular system, and/or may also include data corresponding to user speech, received data and/or user generated data. In this regard, the device 100 may be capable of operating with one or more air interface standards, communication protocols, modulation types, and access types. By way of illustration, the device 100 may be capable of operating in accordance with any of a number of first, second, third and/or fourth-generation communication protocols or the like. For example, the device 100 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA1000, wideband CDMA (WCDMA) and time division-synchronous CDMA (TD-SCDMA), with 3.9G wireless communication protocol such as evolved-universal terrestrial radio access network (E-UTRAN), with fourth-generation (4G) wireless communication protocols, or the like. As an alternative (or additionally), the device 100 may be capable of operating in accordance with non-cellular communication mechanisms. For example, computer networks such as the Internet, local area network, wide area networks, and the like; short range wireless communication networks such as include Bluetooth® networks, Zigbee® networks, Institute of Electric and Electronic Engineers (IEEE) 802.11x networks, and the like; wireline telecommunication networks such as public switched telephone network (PSTN).

The controller 108 may include circuitry implementing, among others, audio and logic functions of the device 100. For example, the controller 108 may include, but are not limited to, one or more digital signal processor devices, one or more microprocessor devices, one or more processor(s) with accompanying digital signal processor(s), one or more processor(s) without accompanying digital signal processor(s), one or more special-purpose computer chips, one or more field-programmable gate arrays (FPGAs), one or more controllers, one or more application-specific integrated circuits (ASICs), one or more computer(s), various analog to digital converters, digital to analog converters, and/or other support circuits. Control and signal processing functions of the device 100 are allocated between these devices according to their respective capabilities. The controller 108 thus may also include the functionality to convolutionally encode and interleave message and data prior to modulation and transmission. The controller 108 may additionally include an internal voice coder, and may include an internal data modem. Further, the controller 108 may include functionality to operate one or more software programs, which may be stored in a memory. For example, the controller 108 may be capable of operating a connectivity program, such as a conventional Web browser. The connectivity program may then allow the device 100 to transmit and receive Web content, such as location-based content and/or other web page content, according to a Wireless Application Protocol (WAP), Hypertext Transfer Protocol (HTTP) and/or the like. In an example embodiment, the controller 108 may be embodied as a multi-core processor such as a dual or quad core processor. However, any number of processors may be included in the controller 108.

The device 100 may also comprise a user interface including an output device such as a ringer 110, an earphone or speaker 112, a microphone 114, a display 116, and a user input interface, which may be coupled to the controller 108. The user input interface, which allows the device 100 to receive data, may include any of a number of devices allowing the device 100 to receive data, such as a keypad 118, a touch display, a microphone or other input device. In embodiments including the keypad 118, the keypad 118 may include numeric (0-9) and related keys (#, *), and other hard and soft keys used for operating the device 100. Alternatively or additionally, the keypad 118 may include a conventional QWERTY keypad arrangement. The keypad 118 may also include various soft keys with associated functions. In addition, or alternatively, the device 100 may include an interface device such as a joystick or other user input interface. The device 100 further includes a battery 120, such as a vibrating battery pack, for powering various circuits that are used to operate the device 100, as well as optionally providing mechanical vibration as a detectable output.

In an example embodiment, the device 100 includes a media capturing element, such as a camera, video and/or audio module, in communication with the controller 108. The media capturing element may be any means for capturing an image, video and/or audio for storage, display or transmission. In an example embodiment in which the media capturing element is a camera module 122, the camera module 122 may include a digital camera capable of forming a digital image file from a captured image. As such, the camera module 122 includes all hardware, such as a lens or other optical component(s), and software for creating a digital image file from a captured image. Alternatively, the camera module 122 may include the hardware needed to view an image, while a memory device of the device 100 stores instructions for execution by the controller 108 in the form of software to create a digital image file from a captured image. In an example embodiment, the camera module 122 may further include a processing element such as a co-processor, which assists the controller 108 in processing image data and an encoder and/or decoder for compressing and/or decompressing image data. The encoder and/or decoder may encode and/or decode according to a JPEG standard format or another like format. For video, the encoder and/or decoder may employ any of a plurality of standard formats such as, for example, standards associated with H.261, H.262/MPEG-2, H.263, H.264, H.264/MPEG-4, MPEG-4, and the like. In some cases, the camera module 122 may provide live image data to the display 116. Moreover, in an example embodiment, the display 116 may be located on one side of the device 100 and the camera module 122 may include a lens positioned on the opposite side of the device 100 with respect to the display 116 to enable the camera module 122 to capture images on one side of the device 100 and present a view of such images to the user positioned on the other side of the device 100.

The device 100 may further include a user identity module (UIM) 124. The UIM 124 may be a memory device having a processor built in. The UIM 124 may include, for example, a subscriber identity module (SIM), a universal integrated circuit card (UICC), a universal subscriber identity module (USIM), a removable user identity module (R-UIM), or any other smart card. The UIM 124 typically stores information elements related to a mobile subscriber. In addition to the UIM 124, the device 100 may be equipped with memory. For example, the device 100 may include volatile memory 126, such as volatile random access memory (RAM) including a cache area for the temporary storage of data. The device 100 may also include other non-volatile memory 128, which may be embedded and/or may be removable. The non-volatile memory 128 may additionally or alternatively comprise an electrically erasable programmable read only memory (EEPROM), flash memory, hard drive, or the like. The memories may store any number of pieces of information, and data, used by the device 100 to implement the functions of the device 100.

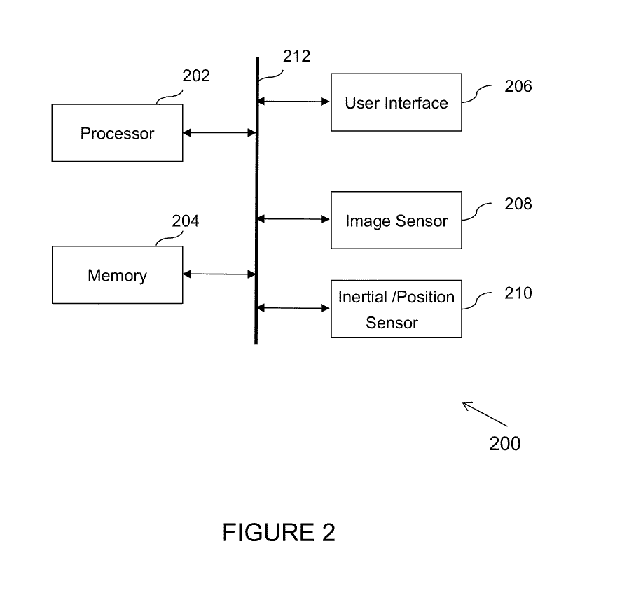

FIG. 2 illustrates an apparatus 200 for capturing of 3-D images in accordance with an example embodiment. The apparatus 200 may be employed, for example, in the device 100 of FIG. 1. However, it should be noted that the apparatus 200, may also be employed on a variety of other devices both mobile and fixed, and therefore, embodiments should not be limited to application on devices such as the device 100 of FIG. 1. In an example embodiment, the apparatus 200 is a mobile phone, which may be an example of a communication device. Alternatively or additionally, embodiments may be employed on a combination of devices including, for example, those listed above. Accordingly, various embodiments may be embodied wholly at a single device, for example, the device 100 or in a combination of devices. It should be noted that some devices or elements described below may not be mandatory and thus some may be omitted in certain embodiments.

The apparatus 200 includes or otherwise is in communication with at least one processor 202 and at least one memory 204. Examples of the at least one memory 204 include, but are not limited to, volatile and/or non-volatile memories. Some examples of the volatile memory includes, but are not limited to, random access memory, dynamic random access memory, static random access memory, and the like. Some example of the non-volatile memory includes, but are not limited to, hard disks, magnetic tapes, optical disks, programmable read only memory, erasable programmable read only memory, electrically erasable programmable read only memory, flash memory, and the like. The memory 204 may be configured to store information, data, applications, instructions or the like for enabling the apparatus 200 to carry out various functions in accordance with various example embodiments. For example, the memory 204 may be configured to buffer input data comprising media content for processing by the processor 202. Additionally or alternatively, the memory 204 may be configured to store instructions for execution by the processor 202.

An example of the processor 202 may include the controller 108. The processor 202 may be embodied in a number of different ways. The processor 202 may be embodied as a multi-core processor, a single core processor; or combination of multi-core processors and single core processors. For example, the processor 202 may be embodied as one or more of various processing means such as a coprocessor, a microprocessor, a controller, a digital signal processor (DSP), a graphic processing unit (GPU), processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the multi-core processor may be configured to execute instructions stored in the memory 204 or otherwise accessible to the processor 202. Alternatively or additionally, the processor 202 may be configured to execute hard coded functionality. As such, whether configured by hardware or software methods, or by a combination thereof, the processor 202 may represent an entity, for example, physically embodied in circuitry, capable of performing operations according to various embodiments while configured accordingly. For example, if the processor 202 is embodied as two or more of an ASIC, FPGA or the like, the processor 202 may be specifically configured hardware for conducting the operations described herein. Alternatively, as another example, if the processor 202 is embodied as an executor of software instructions, the instructions may specifically configure the processor 202 to perform the algorithms and/or operations described herein when the instructions are executed. However, in some cases, the processor 202 may be a processor of a specific device, for example, a mobile terminal or network device adapted for employing embodiments by further configuration of the processor 202 by instructions for performing the algorithms and/or operations described herein. The processor 202 may include, among other things, a clock, an arithmetic logic unit (ALU) and logic gates configured to support operation of the processor 202.

A user interface 206 may be in communication with the processor 202. Examples of the user interface 206 include, but are not limited to, input interface and/or output user interface. The input interface is configured to receive an indication of a user input. The output user interface provides an audible, visual, mechanical or other output and/or feedback to the user. Examples of the input interface may include, but are not limited to, a keyboard, a mouse, a joystick, a keypad, a touch screen, soft keys, and the like. Examples of the output interface may include, but are not limited to, a display such as light emitting diode display, thin-film transistor (TFT) display, liquid crystal displays, active-matrix organic light-emitting diode (AMOLED) display, a microphone, a speaker, ringers, vibrators, and the like. In an example embodiment, the user interface 206 may include, among other devices or elements, any or all of a speaker, a microphone, a display, and a keyboard, touch screen, or the like. In this regard, for example, the processor 202 may comprise user interface circuitry configured to control at least some functions of one or more elements of the user interface 206, such as, for example, a speaker, ringer, microphone, display, and/or the like. The processor 202 and/or user interface circuitry comprising the processor 202 may be configured to control one or more functions of one or more elements of the user interface 206 through computer program instructions, for example, software and/or firmware, stored on a memory, for example, the at least one memory 204, and/or the like, accessible to the processor 202.

In an example embodiment, the apparatus 200 may include an electronic device. Some examples of the electronic device include communication device, media capturing device with communication capabilities, computing devices, and the like. Some examples of the communication device may include a mobile phone, a personal digital assistant (PDA), and the like. Some examples of computing device may include a laptop, a personal computer, and the like. In an example embodiment, the communication device may include a user interface, for example, the UI 206, having user interface circuitry and user interface software configured to facilitate a user to control at least one function of the communication device through use of a display and further configured to respond to user inputs. In an example embodiment, the communication device may include a display circuitry configured to display at least a portion of the user interface of the communication device. The display and display circuitry may be configured to facilitate the user to control at least one function of the communication device.

In an example embodiment, the communication device may be embodied as to include a transceiver. The transceiver may be any device operating or circuitry operating in accordance with software or otherwise embodied in hardware or a combination of hardware and software. For example, the processor 202 operating under software control, or the processor 202 embodied as an ASIC or FPGA specifically configured to perform the operations described herein, or a combination thereof, thereby configures the apparatus or circuitry to perform the functions of the transceiver. The transceiver may be configured to receive media content. Examples of media content may include audio content, video content, data, and a combination thereof.

In an example embodiment, the communication device may be embodied as to include an image sensor, such as an image sensor 208. The image sensor 208 may be in communication with the processor 202 and/or other components of the apparatus 200. The image sensor 208 may be in communication with other imaging circuitries and/or software, and is configured to capture digital images or to make a video or other graphic media files. The image sensor 208 and other circuitries, in combination, may be an example of the camera module 122 of the device 100.

In an example embodiment, the communication device may be embodied as to include an inertial/position sensor 210. The inertial/position sensor 210 may be in communication with the processor 202 and/or other components of the apparatus 200. The inertial/positional sensor 210 may be in communication with other imaging circuitries and/or software, and is configured to track movement/navigation of the apparatus 200 from one position to another position.

These components (202-210) may communicate to each other via a centralized circuit system 212 to perform capturing of 3-D image of a scene. The centralized circuit system 212 may be various devices configured to, among other things, provide or enable communication between the components (202-210) of the apparatus 200. In certain embodiments, the centralized circuit system 212 may be a central printed circuit board (PCB) such as a motherboard, main board, system board, or logic board. The centralized circuit system 212 may also, or alternatively, include other printed circuit assemblies (PCAs) or communication channel media.

In an example embodiment, the processor 202 is configured to, with the content of the memory 204, and optionally with other components described herein, to cause the apparatus 200 to capture two images of a scene with a single camera for generating 3-D image of the scene. In an example embodiment, the apparatus 200 is caused to generate a 3-D image from the pair of images captured by the image sensor 208 along with other circuitries. In an example embodiment, the 3-D images are generated by processing two images of the scene where these images are captured from two different positions of the apparatus 200. In an example embodiment, the processor 202 is configured to, with the content of the memory 204, and the inertial/position sensor 210 for facilitating in moving of the apparatus 200 from one position to another position for capturing two different images of the scene. In an example embodiment, the processor 202 is configured to, with the content of the memory 204, and optionally with other components described herein, to cause the apparatus 200 to operate in an application framework where the movement of the apparatus 200 is tracked to position the apparatus 200 at a first position and a second position for capturing a first image and a second image of the scene, respectively.

In various example embodiments, the processor 202 is configured to, with the content of the memory 204, and optionally with other components described herein, to cause the apparatus 200 to facilitate capturing a first image of a scene. The scene may include at least one object at various distances from the camera of the apparatus. In some forms, the scene may include a single object such as a person. In some forms, the scene may include multiple objects at different distances from the camera of the apparatus, for example, a playground having various players. Herein, camera of the apparatus refers to a set of components including the image sensor 208 and other circuitries utilized for capturing images. In an example embodiment, the apparatus 200 is caused to facilitate capture of a first image of the scene from a first position of the apparatus 200. In an example embodiment, the apparatus 200 facilitates capturing of the first image by initializing the camera of the apparatus 200.

In an example embodiment, the apparatus 200 is caused to track a movement of the apparatus 200 from the first position to the second position. In an example embodiment, tracking of the movement of the apparatus facilitates a user or an automatic mechanism using the apparatus 200 to move the apparatus 200 from the first position to the second position. In one form, information obtained from tracking the movement of the apparatus may be provided as a feedback to the user or the automatic mechanism to move the apparatus from one position to another. The processor 202 is configured to, with the content of the memory 204, and optionally with other components described herein, to cause the apparatus 200 to facilitate capturing a second image of the scene from the second position of the apparatus 200. The processor 202 is configured to, with the content of the memory 204, and optionally with other components described herein, to cause the apparatus 200 to generate a 3-D image from the captured first image and the second image of the scene.

In an example embodiment, the movement of the apparatus 200 from the first position to the second position may be tracked based on the inertial/position sensor 210. In an example embodiment, the inertial/position sensor 210 may be a part of the apparatus 200. In another example embodiment, the inertial/position sensor 210 may be communicably coupled to, controlled by, or accessed by the apparatus 200. Examples of such sensors may non-exhaustively include one or any combination of a gyroscope, an accelerometer, a magnetometer, a quartz rate sensor and other motion sensing devices.

In an example embodiment, the inertial/position sensor 210, along with other components may provide information associated with a measurement of the location of the first position of the apparatus 200. In an example embodiment, the inertial/position sensor 210, along with other components may provide information associated with a displacement of the apparatus 200 with respect to the measurement of the first position while the apparatus 200 is moved from the first position towards the second position. In some example embodiments, a distance between the first position and the second position of the apparatus 200 is pre-defined distance (dx) in a particular direction, and the pre-defined distance may be termed as a ‘stereo-base distance’.

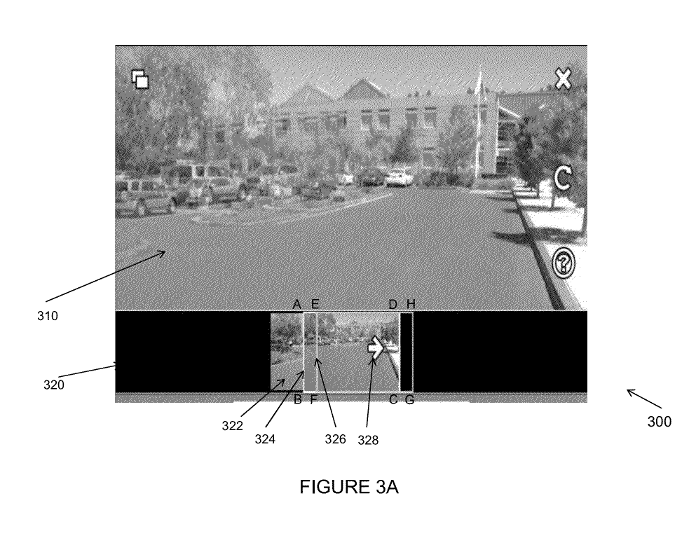

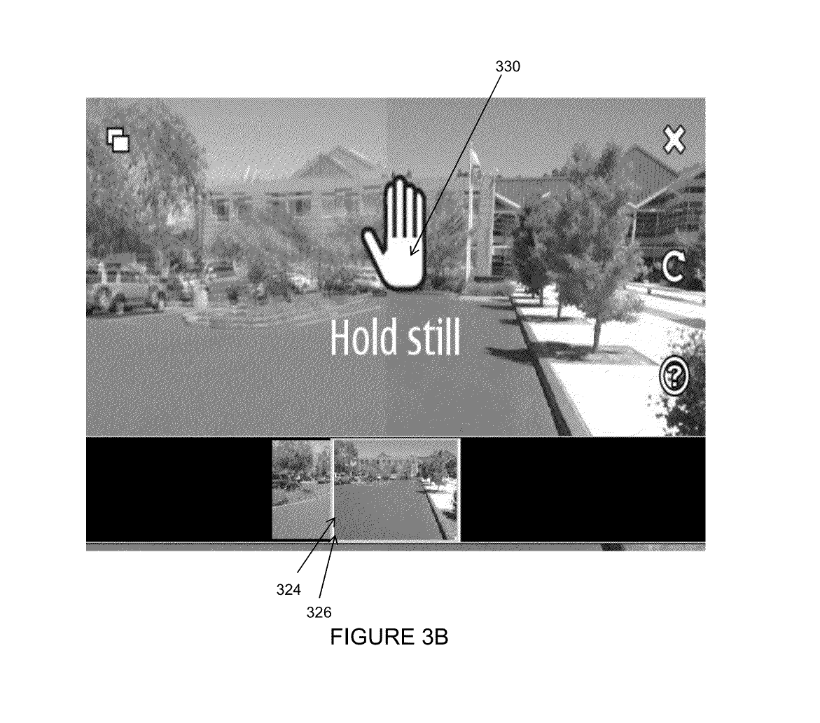

In an example embodiment, while moving the apparatus 200, if the displacement of the apparatus 200 is equal to the stereo-base distance (dx) from the first position, the second position of the apparatus 200 may be determined from where the second image of the scene may be captured. For instance, the processor 202 may receive the measurement of the location of the first position and displacement of the apparatus 200 from the first position through the inertial/position sensor 210, such as the gyroscope. In an example embodiment, if the displacement is equal to the stereo-base, the current position of the apparatus 200 may be determined as the second position. In some example embodiments, the apparatus 200 may be caused to provide movement guiding information for facilitating in moving the apparatus 200 in a particular direction (for example, from the first position to the second position). For instance, providing the movement guiding information may include displaying an arrow on the UI 206 (for example, a viewfinder), where the arrow may point a direction of the second position from a current position of the apparatus 200. The movement guiding information is further described in FIGS. 3A and 3B.

In various example embodiments, the stereo-base distance may be selected from one or more pre-defined values of stereo-base distance. In an example embodiment, the apparatus 200 is caused to use an application framework that may provide option of user choices to selecting stereo-base distances suitable for estimating various depths of the objects in the images. In an example embodiment, the stereo-base distance may be selected from the various pre-defined values based on the distances of the objects of the scene of interest that is to be captured by the apparatus 200. For instance, for a scene having objects lying in a region near to the apparatus 200, the stereo-base distance may be equal to approximate difference between human left and right eyes, for example, about 6.5 centimeters (cm). In an example embodiment, for estimating very far depths, the stereo-base distance may be selected as a value greater than 6.5 cm (for example, about 10 cm in one embodiment). In an example embodiment, if the scene of interest is located far from the apparatus 200, the stereo-base distance may be greater than 6.5 cm.

In an example embodiment, the apparatus 200 is caused to determine a stereo-correspondence between the captured images of the scene, for example, the first image and the second image, and to estimate a depth map of objects in the scene. In an example embodiment, from the first image and the second image, the depth map of the objects in the scene may be estimated using a correspondence finding algorithm, and the correspondence may be mapped to a real world depth using offline calibration. In an example embodiment, a 3-D image may be generated using the first image, the second image and the depth map of the objects in the scene. In an example embodiment, the apparatus 200 may be caused to store and/or display the first image and the second image with the depth information of at least one object in at least one of the first image and the second image. For example, the estimated depth information is displayed as overlaid on corresponding objects on the UI of the apparatus 200 (for example, on the viewfinder of the camera of the apparatus 200). In an example embodiment, the depth information are overlaid on the objects in second image, however, the depth information may also be displayed on the corresponding objects of the first image by using the stereo-correspondence. In some example embodiments, the first and the second image can be stored with the depth information of the object as an overlaid comment and the images may be stored with the depth information of the objects in the images.

In various example embodiments, the first image and the second image are described for the example purposes only. In some example embodiment, more than two images may be captured from different positions for generating the 3-D image. In some example embodiments, the first image and the second image may be substantially similar. For example, in some forms, the first image and the second image may be at least 90 percent similar. In some forms, the first image and the second image may be at least 80 percent similar. In some other forms, the first image and the second image may be at least 70 percent similar. In some other forms, the first image and the second image may have a reasonable percentage of similarity so that these images may be utilized for generating 3-D image. Various embodiments of capturing of 3-D image are further described in FIGS. 3A to 6.

FIGS. 3A and 3B illustrate user interface for facilitating movement of the apparatus 200, in accordance with an example embodiment. For instance, the UI such as a viewfinder is shown representing the movement of the apparatus 200 towards the second position from the first position after capturing the first image, in accordance with an example embodiment. The first image may be captured by an apparatus such as the apparatus 200 from a first position of the apparatus 200. In FIG. 3A, a display 300 is shown that may be displayed on a display screen (UI 206) of the apparatus 200. In the example embodiment as shown in the FIG. 3A, the apparatus 200 is caused to display a scene area 310 and a tracking area 320 at the display 300.

In an example embodiment, the scene area 310 displays a viewfinder of the image capturing application of the apparatus 200. For instance, as the apparatus 200 moves in a direction, the preview of a current scene focused by the camera of the apparatus 200 also changes and is simultaneously displayed in the screen area 310, and the preview displayed on the screen area 310 can be instantaneously captured by the apparatus 200 as an image. In an example embodiment, the tracking area 320 provides the movement information for facilitating movement of the apparatus 200 from one position to another position. In the tracking area 320, a plurality of windows may be displayed. For instance, a first image window 322 displays a thumbnail of the first image captured by the apparatus 200. A tracking window 324 (within area ‘ABCD’) represents a thumbnail of the current scene focused by the camera. In this example embodiment, a target window 326 (within area ‘EFGH’) is a window corresponding to the second position of the apparatus 200. In an example embodiment, the target window 326 is at certain distance apart from the first image window 322, and such distance is analogous to the stereo-base distance selected for capturing the 3-D image of the scene.

In the tracking window 324, a sign such as an arrow 328 may be displayed that represents direction of the movement of the apparatus 200. In an example embodiment, after capturing the first image, the apparatus 200 is moved towards the second position for capturing the second image of the scene. In an example embodiment, if the apparatus 200 is moved in a wrong direction, the tracking window 324 does not move towards the target window 326, and a notification of a wrong direction may be displayed. In an example embodiment, the color of the boundary of the tracking window 324 may change its color from an existing color. For instance, the boundary or an entire or partial area of the tracking window 324 may changes its color to ‘red’ if the direction of the arrow 328 is not towards the second position.

In certain example embodiments, the apparatus 200 is moved in a horizontal direction from the first position to the second position. If the apparatus 200 is moved such that the movement from the first position to the second position is not in horizontal direction, a notification of the wrong movement may also be displayed. For instance, color of the boundary, or at least a portion of the area of the tracking window 324 may be changed to ‘red’ color. Alternatively, some sign or text displaying the wrong movement, or some sound may be presented for notifying the wrong movement of the apparatus 200.

Referring now to FIG. 3B, a viewfinder 300 is shown when the apparatus 200 is moved to the second position to capture the second image of the scene. In an example embodiment, as the apparatus 200 is navigated to the second position, the tracking window 324 aligns with the target window 326. In certain example embodiments, as the tracking window 324 aligns with the target window 326, a notification may be displayed that represents that the apparatus 200 is in the second position, and the second image may be captured. For example, a sign 330 (image of a ‘palm’ and/or a message ‘hold still’) is displayed that notifies a user moving the apparatus 200 to stop movement as the apparatus 200 is in the second position from where the second image of the scene may be captured.

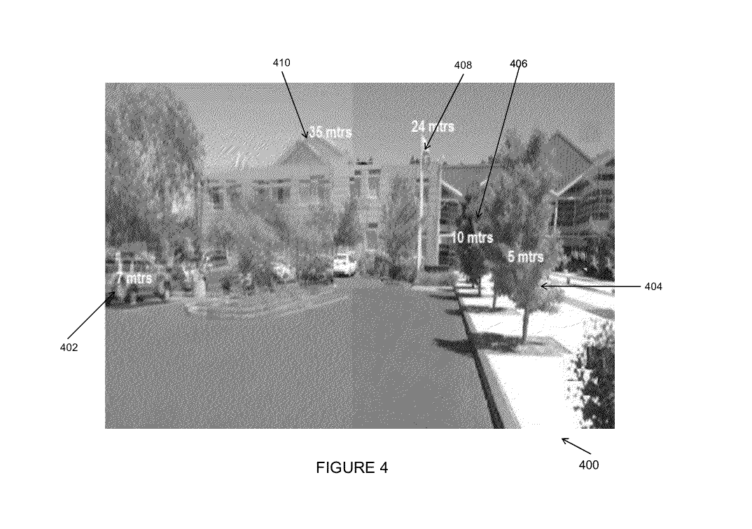

In an example embodiment, the apparatus 200 is caused to process the first image and the second image to generate the 3-D image of the scene. In an example embodiment, the first image and the second image may be processed by a stereo-correspondence computing algorithm, and the depths of objects/visual stimuli in the scene may be computed. In an example embodiment, the depths of the objects/visual stimuli can be overlaid onto the screen and displayed to the user in the post-image preview and/or can be stored along with the image. An image is shown in FIG. 4, on which the distances of some of the objects of the image are overlaid as comments.

FIG. 4 represents an image 400 having depth information overlaid on the image 400, in accordance with an example embodiment. In an example, the image 400 may be the second image that may be captured by the apparatus 200 after the apparatus 200 is moved to the second position as shown in FIG. 3B. In an example representation, some of the objects of the image 400 are shown by reference numerals 402, 404, 406, 408 and 410. As shown in this FIG. 4, the depths of the object 402, 404, 406, 408 and 410 are displayed as 7 meters (mtrs), 5 mtrs, 10 mtrs, 24 mtrs, and 35 mtrs, respectively. These distances are overlaid onto the screen and displayed to the user as a viewfinder display so that user can view the distances at real time.

In various example embodiments, an apparatus such as the apparatus 200 may comprise various components such as means for means for facilitating capturing of a first image of a scene by the apparatus from a first position of the apparatus; means for tracking a movement of the apparatus for facilitating movement of the apparatus from the first position to a second position; and means for facilitating capturing of a second image of the scene by the apparatus from the second position of the apparatus. Such components may be configured by utilizing hardware, firmware and software components. Examples of such means may include, but is not limited to, the processor 202 along with memory 204, the UI 206, the image sensor 208, and the inertial/position sensor 210. In an example embodiment, the means for the means for tracking the movement of the apparatus comprises means for performing at least a measurement of location of the first position and means for determining at least a displacement of the apparatus from the measurement of the first position upon movement of the apparatus. Examples of such means may include the processor 202 in combination with the image sensor 208 and the inertial/position sensor 210.

In an example embodiment, the apparatus further comprises means comparing a displacement of the apparatus from the first position with a stereo-base distance, and means for determining the second position based on the comparison of the displacement with the stereo-base distance. In an example embodiment, the apparatus further comprises means for selecting the stereo-base distance from one or more pre-defined values of the stereo-base distance based at least on a distance of at least one object of the scene from the apparatus. In an example embodiment, the apparatus further comprises means for generating a 3-D image of the scene based at least on the first image and the second image. Examples of such means may include, but is not limited to, the processor 202 along with memory 204, the UI 206, the image sensor 208, and the inertial/position sensor 210.

In an example embodiment, the means for generating the 3-D image comprises means for determining a stereo-correspondence between the first image and the second image, and means for estimating a depth map of at least one object in at least one of the first image and the second image based on the correspondence between the first image and the second image. In an example embodiment, the apparatus comprises means for storing the first image and the second image, wherein at least one of the first image and the second image is stored with a depth information associated with at least one object of the scene. In an example embodiment, the apparatus further comprises means for displaying a depth information associated with at least one object in the second image on a viewfinder display of the apparatus. Examples of such means may include, but is not limited to, the processor 202 along with memory 204, the UI 206, the image sensor 208, and the inertial/position sensor 210.

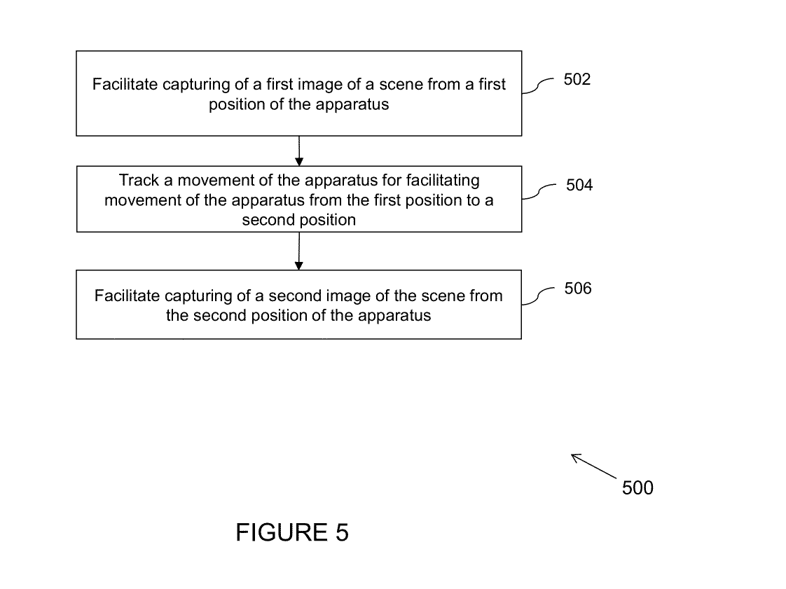

FIG. 5 is a flowchart depicting an example method 500 in accordance with an example embodiment. The method 500 depicted in flow chart may be executed by, for example, the apparatus 200. It may be understood that for describing the method 500, references herein may be made to FIGS. 1-4.

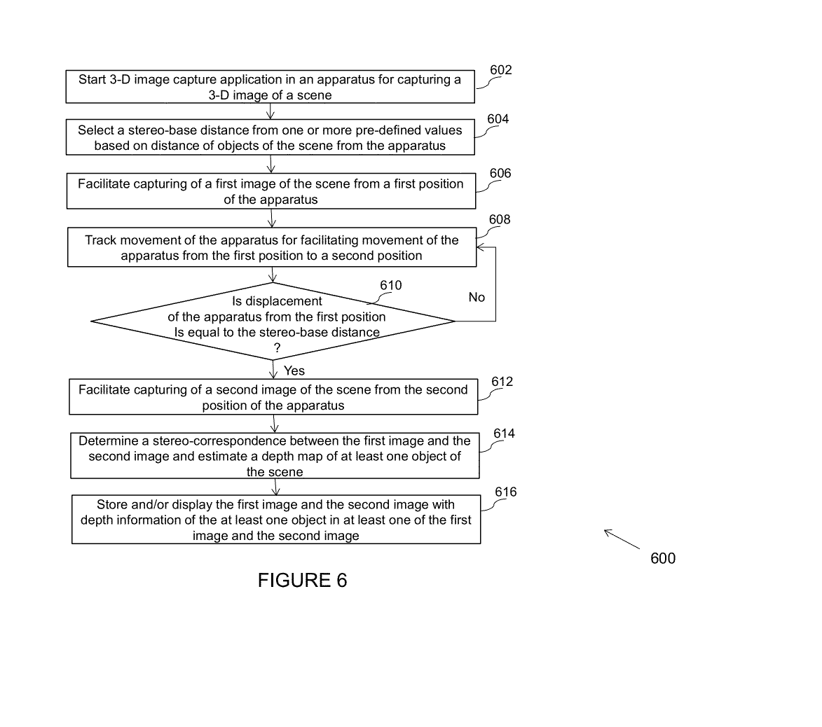

At block 502, the method 500 includes facilitating capturing of a first image of a scene by an apparatus. The first image is captured from a first position of the apparatus. At block 504, the method 500 includes tracking a movement of the apparatus during movement of the apparatus from the first position to a second position. At block 506, the method 500 includes facilitating capturing of a second image of the scene by the apparatus from the second position of the apparatus. Various embodiments of capturing of 3-D images are further described in FIG. 6.

FIG. 6 is a flowchart depicting an example method 600 for generating 3-D images by an apparatus in accordance with an example embodiment. The method 600 depicted in flow chart may be executed by, for example, the apparatus 200. It may be understood that for describing the method 600, references herein may be made to FIGS. 1-4. It should be noted that that although the method 600 of FIG. 6 shows a particular order, the order need not be limited to the order shown, and more or fewer blocks may be executed, without providing substantial change to the scope of the various example embodiments.

At 602, the method 600 starts and a 3-D image capture application is launched in an apparatus having image capturing capabilities for capturing a 3-D image of a scene. At block 604, the method 600 includes selecting a stereo-base distance from one or more pre-defined values of the stereo-base distance. In an example embodiment, the stereo-base distance is selected based on the distance of the scene from the apparatus. For example, the stereo-base distance is selected from the pre-defined values based on the distance of the at least one object of the scene from the apparatus. For instance, if the objects of the scene are in a near region from the apparatus, the stereo-base may be selected as about 6.5 cm; and if the objects of the scene are in a far region from the apparatus, the stereo-base may be selected as about to 10 cm. The stereo-base distances such as 6.5 cm and 10 cm are for example purposes only and such distances may have other values depending upon the location of the scene with respect to the apparatus.

At block 606, the method 600 includes facilitating capture of a first image of the scene from a first position of the apparatus. In an example embodiment, the method 600 facilitates capturing the first image through image capturing means such as image sensors in the apparatus. At 608, the method 600 includes tracking movement of the apparatus for facilitating movement of the apparatus from the first position to a second position. In an example embodiment, movement of the apparatus may be tracked by triggering movement tracking means such as an inertial sensor or a position sensor, in the apparatus. In an example embodiment, a measurement of the location of the first position may be performed, and a displacement of the apparatus may be determined from the measurement of the first position upon movement of the apparatus.

At block 610, the method 600 includes checking whether displacement of the apparatus is equal to the stereo-base distance, upon movement of the apparatus from the first position to the second position. In an example embodiment, the displacement of the apparatus is compared with the stereo-base distance. In an example embodiment, if the displacement of the apparatus is equal to the stereo-base distance, the second position may be determined. If it is determined that the displacement is equal to the stereo-base (for example, the apparatus reaches the second position), the method 600 proceeds to block 612. At block 612, the method 600 includes facilitating capturing of the second image from the second position of the apparatus. In an example embodiment, the second image is captured by the same image capturing means that captures the first image, present in the apparatus. In an example embodiment, method 600 includes providing a movement guiding information associated with the movement of the apparatus on a user interface of the apparatus. For instance, as the apparatus reaches the second position (also, the displacement become equal to the stereo-base distance), the movement information such as messages including ‘hold still’ or ‘no further movement’ or ‘second position reached’ or ‘left/right image position’, and the like may be displayed on a user interface of the apparatus.

At block 610, if the displacement of the apparatus is not equal to the stereo-base distance, the apparatus is moved towards the second position. In an example embodiment, movement guiding information such as an arrow pointing towards the second position may be displayed to assisting user or an automatic mechanism using the apparatus in moving the apparatus towards the second position. In some example embodiments, if providing the movement information may include displaying an error message display if the movement of the apparatus is not directed towards the second position from the first position. In some forms, the errors message display may be a text message display. Alternatively, the errors message may be in forms of some color based representation on the UI of the apparatus.

At block 614, the method 600 includes determining a stereo-correspondence between the first image and the second image, and estimating a depth map of objects in the scene. In an example embodiment, from the first image and the second image, depth map of the objects in the scene may be estimated using a correspondence finding algorithm, and the correspondence is mapped to the real world depth using offline calibration. In an example embodiment, a 3-D image may be generated using the first image and the second image and the depth map of the objects in the scene. In some example embodiments, the stereo-correspondence between the first image and the second image may be determined by matching pixels of the first image and the second image. In some example embodiments, the stereo-correspondence may be determined by matching at least one feature of the first image and the second image. For example, features such as corners, edges of an image, or other region of interest such as background of the first image and the second image may be matched. In some example embodiments, the method includes determining a disparity information between the first image and the second image for estimating the depth map. In an example embodiment, the disparity information may be determined utilizing the stereo-correspondence. For example, one of the first image and the second image may be set as a reference image and the other image is set as a search image. In an example embodiment, the disparity information may be determined based on a distance between the reference image and the search image with respect to a same point in a space of the first and second images. In an example embodiment, the disparity information of the stereo image is required to determine the depth information (Z coordinate) of objects in the image. In an example embodiment, the Z coordinate (depth information) is required to generate the three-dimensional image from the two-dimensional images in addition to coordinates X and Y, which are vertical and horizontal positional information of the two-dimensional images, respectively.

In an example embodiment, at block 616, the method 600 includes storing and/or displaying the first image and the second image with depth information of at least one object in at least one of the first image and the second image. For example, the estimated depth is displayed as overlaid on corresponding objects on the UI of the apparatus (for example, on the viewfinder of the apparatus). In an example embodiment, corresponding depth information is overlaid on the objects in second image; however, the depths may also be displayed on the corresponding objects of the first image. In some example embodiments, the first and the second image can be stored with object's depth information as overlaid comments and the image is stored with the depth information.

Operations of the flowcharts 500 or 600, and combinations of operations in the flowcharts 500 or 600, may be implemented by various means, such as hardware, firmware, processor, circuitry and/or other device associated with execution of software including one or more computer program instructions. For example, one or more of the procedures described in various embodiments may be embodied by computer program instructions. In an example embodiment, the computer program instructions, which embody the procedures, described in various embodiments may be stored by at least one memory device of an apparatus and executed by at least one processor in the apparatus. Any such computer program instructions may be loaded onto a computer or other programmable apparatus (for example, hardware) to produce a machine, such that the resulting computer or other programmable apparatus embody means for implementing the operations specified in the flowcharts 500 or 600. These computer program instructions may also be stored in a computer-readable storage memory (as opposed to a transmission medium such as a carrier wave or electromagnetic signal) that may direct a computer or other programmable apparatus to function in a particular manner, such that the instructions stored in the computer-readable memory produce an article of manufacture the execution of which implements the operations specified in the flowchart. The computer program instructions may also be loaded onto a computer or other programmable apparatus to cause a series of operations to be performed on the computer or other programmable apparatus to produce a computer-implemented process such that the instructions, which execute on the computer or other programmable apparatus provide operations for implementing the operations in the flowchart. The operations of the methods 500 and 600 are described with help of the apparatus 200. However, the operations of the methods 500 and 600 can be described and/or practiced by using any other apparatus.

Without in any way limiting the scope, interpretation, or application of the claims appearing below, a technical effect of one or more of the example embodiments disclosed herein is to generate 3-D images using a single camera. Various embodiments utilize inertial/position sensors to move the apparatus having a single camera to move from a first position to a second position for capturing a pair of images that are used for generating the 3-D image. Various embodiments provide the display of the depth information of objects as overlaid on the images that can easily explain the contents of the image. Various embodiments can be implemented in any apparatus having at least one camera to enable the apparatus to capture 3-D images.

Various embodiments described above may be implemented in software, hardware, application logic or a combination of software, hardware and application logic. The software, application logic and/or hardware may reside on at least one memory, at least one processor, an apparatus or, a computer program product. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of an apparatus described and depicted in FIGS. 1 and/or 2. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with other. Furthermore, if desired, one or more of the above-described functions may be optional or may be combined.

Although various aspects of the embodiments are set out in the independent claims, other aspects comprise other combinations of features from the described embodiments and/or the dependent claims with the features of the independent claims, and not solely the combinations explicitly set out in the claims.

It is also noted herein that while the above describes example embodiments, these descriptions should not be viewed in a limiting sense. Rather, there are several variations and modifications, which may be made without departing from the scope of the present disclosure as, defined in the appended claims.

What is claimed is:

1. A method comprising:
facilitating capturing of a first image of a scene from a first position of an apparatus;
performing at least a measurement of location of the first position;
determining at least a displacement of the apparatus from the first position upon movement of the apparatus;
comparing a displacement of the apparatus from the first position with a stereo-base distance;
determining the second position based on the comparison of the displacement with the stereo-base distance;
facilitating capturing of a second image of the scene from the second position of the apparatus; and
generating a three-dimensional image of the scene based at least on the first image and the second image.

2. The method as claimed in claim 1, further comprising selecting the stereo-base distance from one or more pre-defined values of the stereo-base distance based at least on a distance of at least one object of the scene from the apparatus.

3. The method as claimed in claim 1, further comprising displaying a tracking window associated with a current position of the apparatus and a target window associated with the second position of the apparatus.

4. The method as claimed in claim 1, wherein generating the three-dimensional image comprises:
determining a stereo-correspondence between the first image and the second image; and
estimating a depth map of at least one object in at least one of the first image and the second image based on the stereo-correspondence between the first image and the second image.

5. The method as claimed in claim 1, further comprising storing the first image and the second image, wherein at least one of the first image and the second image is stored with a depth information associated with at least one object of the scene.

6. The method as claimed in claim 5, further comprising displaying a depth information associated with at least one object in the second image on a viewfinder display of the apparatus.

7. The method as claimed in claim 1, wherein the first image and the second image are substantially similar.

8. An apparatus comprising:
at least one processor; and
at least one memory comprising computer program code, the at least one memory and the computer program code configured to, with the at least one processor, cause the apparatus at least to perform:
facilitate capturing of a first image of a scene from a first position of the apparatus;
perform at least a measurement of location of the first position;
determine at least a displacement of the apparatus from the first position upon movement of the apparatus;
compare a displacement of the apparatus from the first position with a stereo-base distance;
determine the second position based on the comparison of the displacement with the stereo-base distance;
facilitate capturing of a second image of the scene from the second position of the apparatus; and
generate a three-dimensional image of the scene based at least on the first image and the second image.

9. The apparatus as claimed in claim 8, wherein the apparatus is further caused, at least in part, to perform: select the stereo-base distance from one or more pre-defined values of the stereo-base distance based at least on a distance of at least one object of the scene from the apparatus.

10. The apparatus as claimed in claim 8, wherein the apparatus is further caused, at least in part, to provide the movement information by displaying a tracking window associated with a current position of the apparatus and a target window associated with the second position of the apparatus.

11. The apparatus as claimed in claim 8, wherein, to generate the three-dimensional image, the apparatus is further caused, at least in part, to perform:
determine a stereo-correspondence between the first image and the second image; and
estimate a depth map of at least one object in at least one of the first image and the second image based on the stereo-correspondence between the first image and the second image.

12. The apparatus as claimed in claim 8, wherein the apparatus is further caused, at least in part, to perform: store the first image and the second image, wherein at least one of the first image and the second image is stored with a depth information associated with at least one object of the scene.

13. The apparatus as claimed in claim 12, wherein the apparatus is further caused, at least in part, to perform: display a depth information associated with at least one object in the second image on a viewfinder display of the apparatus.

14. The apparatus as claimed in claim 8, wherein the first image and the second image are substantially similar.

15. A computer program product comprising at least one computer-readable storage medium, the computer-readable storage medium comprising a set of instructions, which, when executed by one or more processors, cause an apparatus at least to perform:
facilitating capturing of a first image of a scene by the apparatus from a first position of the apparatus;
determining at least a displacement of the apparatus from the first position upon movement of the apparatus;
comparing a displacement of the apparatus from the first position with a stereo-base distance;
determining the second position based on the comparison of the displacement with the stereo-base distance;
facilitating capturing of a second image of the scene by the apparatus from the second position of the apparatus; and
generating a three-dimensional image of the scene based at least on the first image and the second image.

16. The computer program product as claimed in claim 15, wherein the apparatus is further caused, at least in part, to perform selecting the stereo-base distance from one or more pre-defined values of the stereo-base distance based at least on a distance of at least one object of the scene from the apparatus.

17. The computer program product as claimed in claim 15, wherein providing the movement information comprises displaying a tracking window associated with a current position of the apparatus and a target window associated with the second position of the apparatus.

18. The computer program product as claimed in claim 15, wherein the apparatus is further caused, at least in part, to generate the three-dimensional image by:
determining a stereo-correspondence between the first image and the second image; and
estimating a depth map of at least one object in at least one of the first image and the second image based on the correspondence between the first image and the second image.

19. The computer program product as claimed claim 15, wherein the apparatus is further caused, at least in part, to perform storing the first image and the second image, wherein at least one of the first image and the second image is stored with a depth information associated with at least one object of the scene.

20. The computer program product as claimed in claim 15, wherein the first image and the second image are substantially similar.
